(19) United States
(12) Patent Application Publication
(10) Pub. No.: US 2016/0110803 A1
(43) Pub. Date: Apr. 21, 2016

(54) AUCTION SERVER, AUCTION CONTROL METHOD, NON-TRANSITORY RECORDING MEDIUM, AND PROGRAM

(71) Applicant: RAKUTEN, INC., Tokyo (JP)

(72) Inventor: Kenta SAKAE, Tokyo (JP)

(73) Assignee: RAKUTEN, INC., Tokyo (JP)

(21) Appl. No.: 14/787,566

(22) PCT Filed: Mar. 10, 2014
(86) PCT No.: PCT/JP2014/056177

§ 371 Date: Oct. 28, 2015

(51) Int. Cl. G06Q 30/08

(52) U.S. Cl. CPC G06Q 30/08

(57) ABSTRACT

A system intermittently lowers a set price at which a product is winnable at an auction, provides the set price of the product to a plurality of users, manages active users indicating an interest in the product from among the users provided with the set price, and receives a bid at the set price from a bidding user. If the time of the received bid is within a predetermined announcement period, an email transmitter announces, to active users excluding the bidding user, counter-bidding at the set price before the relevant price lowering. The system receives a counter-bid from a counter-bidding user among the active users to which counter-bidding was announced, until a counter-bidding deadline determined from the price lowering time or the bid time, and decides a winning user on the basis of the bid and the counter-bid received.

### TECHNICAL FIELD

The present disclosure relates to an auction server, an auction control method, a non-transitory recording medium, and a program.

### BACKGROUND ART

Recently, auction sites that convene auctions over the Internet are enjoying popularity. For example, many users utilize large-scale auction sites because products from a wide variety of categories (genres) are offered for sale. On such auction sites, there also exist “buy-it-now” auctions in which, if a user bids at a price set for the product, the user is able to win the auction immediately without competing with other users.

As a technology of the related art regarding such buy-it-now auctions, Patent Literature 1 discloses a buy-it-now price varying auction server that varies the current price according a degree of attention.

### CITATION LIST

### Patent Literature

Patent Literature 1: Unexamined Japanese Patent Application Kokai Publication No. 2009-193236

### SUMMARY OF INVENTION

### Technical Problem

There also exist auction sites that combine a buy-it-now auction discussed above with “automatic price lowering”. Automatic price lowering is an auction in which, every time a bidding period ends without any bids, the product is put up for auction again with the price lowered automatically. On auctions with such automatic price lowering, users wanting to bid often wait to bid until the product is automatically lowered in price, in order to win the auction at a lower price. Additionally, such users often bid after the automatic price lowering, and win the auction at the lowered price. Among such users, there are even users who do not bid even after the price is automatically lowered multiple times, and wait until the price is automatically lowered to the lowest price.

In this way, in an automatic price lowering auction, there is often a long period until the auction is bid on (or won), which increases the management burden and the like on the users who put up products for auction. Also, since there is a long period until bidding, the winning price also falls naturally, imposing a double burden on users who put up products for auction. For this reason, in an automatic price lowering auction, the development of technology that obtains bids from users sooner is desirable.

The present disclosure has been devised in light of the above circumstances, and takes as an objective thereof to provide an auction server, an auction control method, a non-transitory recording medium, and a program enabling bids from users to be obtained sooner in an automatic price lowering auction.

### Solution to Problem

An auction server according to a first aspect of the present disclosure includes:
an updater that intermittently lowers a set price at which a product put up for auction is winnable;
a provider that provides the current set price of the product to a plurality of users;
a manager that manages one or more active users indicating an interest in the product from among the plurality of users provided with the set price;
a bid receiver that receives a bid at the current set price for the product from a bidding user among the plurality of users;
an announcer that, if a bid time at which the bid is received by the bid receiver is within a predetermined announcement period starting from a time of a price lowering of the product by the updater, announces, to the active users excluding the bidding user, counter-bidding at the set price for the product prior to the relevant price lowering;
a counter-bid receiver that receives a counter-bid from a counter-bidding user among the active users to which counter-bidding was announced, until a counter-bidding deadline determined from the price lowering time or the bid time; and
a decider that decides a winning user on the basis of the bid received by the bid receiver and the counter-bid received by the counter-bid receiver.

Also, in the auction server according to the above aspect,
the announcer varies the announcement period according to the number of active users.

Also, in the auction server according to the above aspect,
the announcer varies the announcement period according to a price lowering amount or a price lowering ratio used by the updater.

Also, in the auction server according to the above aspect,
the counter-bidding deadline is equal to the end of the announcement period, or after a fixed period elapses from the bid time.

Also, the auction server according to the above aspect additionally includes:
a granter that, on the condition that the decider decides that the counter-bidding user is the winning user, grants some or all of points to be granted to the winning user for use when paying for a product won by auction to the bidding user.

An auction control method according to a second aspect of the present disclosure is an auction control method in a server that controls an auction, including:
an updating step that intermittently lowers a set price at which a product put up for auction is winnable;
a providing step that provides the current set price of the product to a plurality of users;
a managing step that manages one or more active users indicating an interest in the product from among the plurality of users provided with the set price;
a bid receiving step that receives a bid at the current set price for the product from a bidding user among the plurality of users;
an announcing step that, if a bid time at which the bid is received by the bid receiving step is within a predetermined announcement period starting from a time of a price lowering of the product by the updating step, announces, to the active users excluding the bidding user, counter-bidding at the set price for the product prior to the relevant price lowering;
a counter-bid receiving step that receives a counter-bid from a counter-bidding user among the active users to which counter-bidding was announced, until a counter-bidding deadline determined from the price lowering time or the bid time; and
deciding step that decides a winning user on the basis of the bid received in the bid receiving step and the counter-bid received in the counter-bid receiving step.

A non-transitory computer-readable recording medium according to a third aspect of the present disclosure stores a program causing a computer to function as:
an updater that intermittently lowers a set price at which a product put up for auction is winnable;
a provider that provides the current set price of the product to a plurality of users;
a manager that manages one or more active users indicating an interest in the product from among the plurality of users provided with the set price;
a bid receiver that receives a bid at the current set price for the product from a bidding user among the plurality of users;
an announcer that, if a bid time at which the bid is received by the bid receiver is within a predetermined announcement period starting from a time of a price lowering of the product by the updater, announces, to the active users excluding the bidding user, counter-bidding at the set price for the product prior to the relevant price lowering;
a counter-bid receiver that receives a counter-bid from a counter-bidding user among the active users to which counter-bidding was announced, until a counter-bidding deadline determined from the price lowering time or the bid time; and
a decider that decides a winning user on the basis of the bid received by the bid receiver and the counter-bid received by the counter-bid receiver.

The above recording medium may be a non-transitory recording medium, and may be distributed or sold independently of the computer. Herein, a non-transitory recording medium refers to a tangible recording medium. The non-transitory recording medium may be a Compact Disc, a flexible disk, a hard disk, a magneto-optical disc, a Digital Video Disc, magnetic tape, or semiconductor memory, for example. Also, a transitory recording medium refers to the transmission medium (propagation signal) itself. The transitory recording medium may be an electrical signal, an optical signal, or an electromagnetic signal, for example. Note that a temporary recording medium is an area for temporarily storing data or programs, and may be volatile memory such as random access memory (RAM), for example.

A program according to a fourth aspect of the present disclosure causes a computer to function as:
an updater that intermittently lowers a set price at which a product put up for auction is winnable;
a provider that provides the current set price of the product to a plurality of users;
a manager that manages one or more active users indicating an interest in the product from among the plurality of users provided with the set price;
a bid receiver that receives a bid at the current set price for the product from a bidding user among the plurality of users;
an announcer that, if a bid time at which the bid is received by the bid receiver is within a predetermined announcement period starting from a time of a price lowering of the product by the updater, announces, to the active users excluding the bidding user, counter-bidding at the set price for the product prior to the relevant price lowering;
a counter-bid receiver that receives a counter-bid from a counter-bidding user among the active users to which counter-bidding was announced, until a counter-bidding deadline determined from the price lowering time or the bid time; and
a decider that decides a winning user on the basis of the bid received by the bid receiver and the counter-bid received by the counter-bid receiver.

The above program may be distributed or sold via a computer communication network, independently of the computer on which the relevant program is executed.

### Advantageous Effects of Invention

According to the present disclosure, it is possible to obtain bids from users sooner in an automatic price lowering auction.

### BRIEF DESCRIPTION OF DRAWINGS

FIG. 1 is a block diagram illustrating an example of an overall configuration of an auction system according to the present embodiment;

FIG. 2 is a block diagram that illustrates an example of a general configuration of a typical information processing device that realizes an auction server and a user terminal;

FIG. 3 is a block diagram illustrating an example of a general configuration of an auction server according to the present embodiment;

FIG. 4 is a schematic diagram for explaining an example of product information;

FIG. 5 is a schematic diagram for explaining an example of auction management information;

FIG. 6 is a schematic diagram for explaining an example of active user management information;

FIG. 7 is a schematic diagram illustrating an example of an auction screen;

FIG. 8 is a schematic diagram illustrating an example of an announcement email;

FIG. 9 is a schematic diagram illustrating an example of a dedicated counter-bidding screen; and

FIG. 10 is a flowchart for describing an auction control process according to the present embodiment.

### DESCRIPTION OF EMBODIMENT

Hereinafter, an embodiment of the present disclosure will be described. In the present embodiment, an auction site (auction system) that holds auctions with automatic price lowering will be described as an example. Also, the embodiment hereinafter is for the purpose of explanation, and does not restrict the scope of the present disclosure. Consequently, although a person ordinarily skilled in the art may be able to adopt embodiments in which some or all of these elements have been substituted with their equivalents, such embodiments are also included in the scope of the present disclosure.

(Overall Configuration)

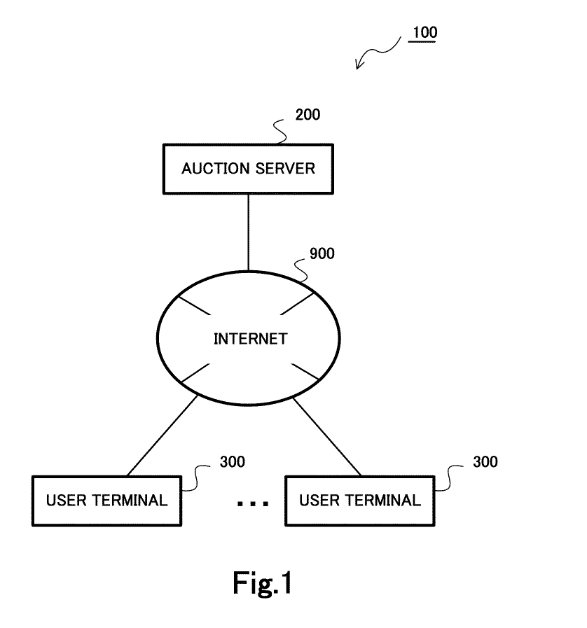

As illustrated in FIG. 1, an auction system 100 according to the present embodiment is made up of an auction server 200 and user terminals 300 connected via the Internet 900. Although simplified in the drawing, suppose that there are a large number of user terminals 300, corresponding to users who use the auction system 100.

The auction server 200 is made up of a device such as a server computer, for example, which provides the user terminals 300 with information related to a product put up for auction, and receives bids on the product or the like from the user terminals 300. As an example, the auction server 200 handles products put up for auction by many users (auctioning users), and categorizes the products in hierarchical categorizes for management. Also, the products put up for auction are auctioned using automatic price lowering, for example. Automatic price lowering is an auction in which, every time a bidding period ends without any bids, the product is put up for auction again with the price lowered automatically.

The user terminal 300 is made up of a PC or smartphone, for example, which accesses the auction server 200 via the Internet 900, and acquires information related to products put up for auction, while also accepting user operations and bidding on a desired product or the like.

(General Configuration of Information Processing Device)

A typical information processing device 400 that realizes the auction server 200 and the user terminal 300 according to the present embodiment will be described.

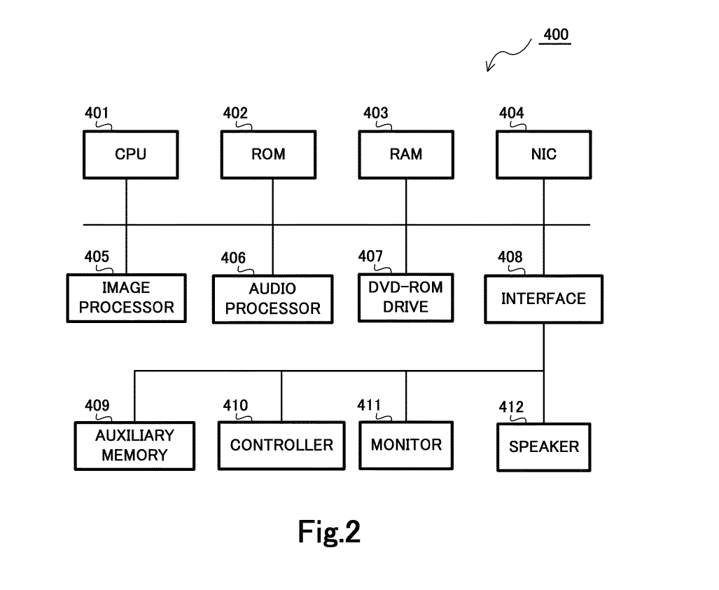

As illustrated in FIG. 2, the information processing device 400 is equipped with a central processing unit (CPU) 401, read-only memory (ROM) 402, random access memory (RAM) 403, a network interface card (NIC) 404, an image processor 405, an audio processor 406, a Digital Versatile Disc ROM (DVD-ROM) drive 407, an interface 408, auxiliary memory 409, a controller 410, a monitor 411, and a speaker 412.

The CPU 401 controls the operation of the information processing device 400 overall, and exchanges control signals and data with connected structural elements.

In the ROM 402, there is recorded an initial program loader (IPL) executed immediately after power-on. By executing the IPL, a predetermined program is loaded into the RAM 403, and the CPU 401 starts execution of the relevant program. Also, in the ROM 402, there are recorded operating system programs and various data required for operational control of the information processing device 400 overall.

The RAM 403 is for temporarily storing data and programs, and holds information such as programs and data read out from a DVD-ROM, as well as other data required for communication.

The NIC 404 is for connecting the information processing device 400 to a computer communication network such as the Internet, and is made up of a device that conforms to the 10BASE-T/100BASE-T standards used to configure a local area network (LAN), an analog modem, an Integrated Services Digital Network (ISDN) modem, or an asymmetric digital subscriber line (ADSL) modem for connecting to the Internet using a telephone line, or a cable model for connecting to the Internet using a cable television line, and an interface (not illustrated) that mediates between the above and the CPU 401.

The image processor 405 uses an image computational processor (not illustrated) provided in the CPU 401 or the image processor 405 to process data read out from a DVD-ROM or the like, and then records the processed data in frame memory (not illustrated) provided in the image processor 405. The image information recorded in the frame memory is converted into a video signal at predetermined synchronization timings, and is output to the monitor 411. As a result, the display of various pages becomes possible.

The audio processor 406 converts audio data read out from a DVD-ROM or the like into an analog audio signal, which is output from a connected speaker 412. Also, under control by the CPU 401, the audio processor 406 generates sounds to be produced during the course of processing conducted by the information processing device 400, and audio corresponding to the sounds is output from the speaker 412.

A DVD-ROM inserted into the DVD-ROM drive 407 stores a program for realizing the auction server 200 according to the present embodiment or the like, for example. Under control by the CPU 401, the DVD-ROM drive 407 conducts a read process on the inserted DVD-ROM, and reads out required programs and data, which are temporarily stored in the RAM 403 or the like.

The auxiliary memory 409, controller 410, monitor 411, and speaker 412 are removably connected to the interface 408.

The auxiliary memory 409 stores information such as data related to a user's personal information in a rewritable manner.

The controller 410 accepts operational input conducted when configuring various settings of the information processing device 400 or the like. The user of the information processing device 400 inputs instructions via the controller 410, and as a result, the data thereof may be recorded in the auxiliary memory 409 as appropriate.

The monitor 411 presents data output by the image processor 405 to the user of the information processing device 400.

The speaker 412 presents audio data output by the audio processor 406 to the user of the information processing device 400.

Besides the above, the information processing device 400 may also be configured to use a high-capacity auxiliary storage device such as a hard disk to fulfill the same functions as components such as the ROM 402, the RAM 403, the auxiliary memory 409, or a DVD-ROM inserted into the DVD-ROM drive 407.

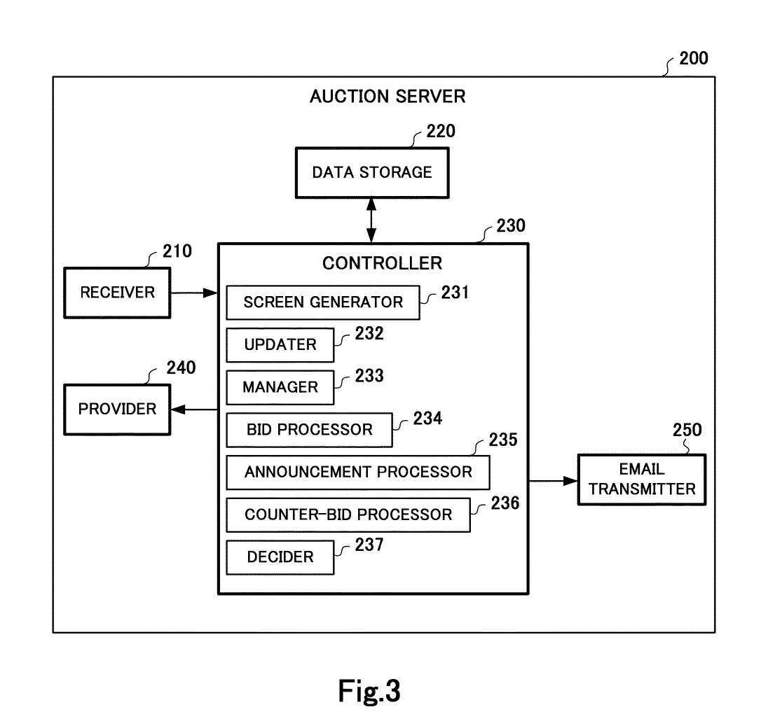

Hereinafter, a configuration and the like of the auction server 200 realized by the above information processing device 400 will be described with reference to FIGS. 3 to 9. When the information processing device 400 is powered on and accessed by a user terminal 300, for example, respective programs for causing the information processing device 400 to function as an auction server 200 according to the present embodiment are executed, and an auction server 200 according to the present embodiment is realized. Note that since the user terminal 300 is similarly realized by the information processing device 400, the configuration is omitted herein, and the auction server 200 that is most characteristic of the present embodiment will be described below.

(General Configuration of Auction Server)

FIG. 3 is a block diagram illustrating an example of a general configuration of an auction server 200 according to the present embodiment. As illustrated in FIG. 3, the auction server 200 is equipped with a receiver 210, data storage 220, a controller 230, a provider 240, and an email transmitter 250.

The receiver 210 receives various information transmitted from the user terminals 300 via the Internet 900. For example, the receiver 210 receives, from a user terminal 300, an instruction to transition to an auction screen for a desired product, and various operation instructions on the auction screen (such as mouse click operations performed by the user, as discussed later). Otherwise, the receiver 210 also receives, from a user terminal 300, information required for registration prior to participating in an auction, such as user information, including an email address, as well as financial account information for making payments or credit card information. The NIC 404 and the like discussed earlier may function as such a receiver 210.

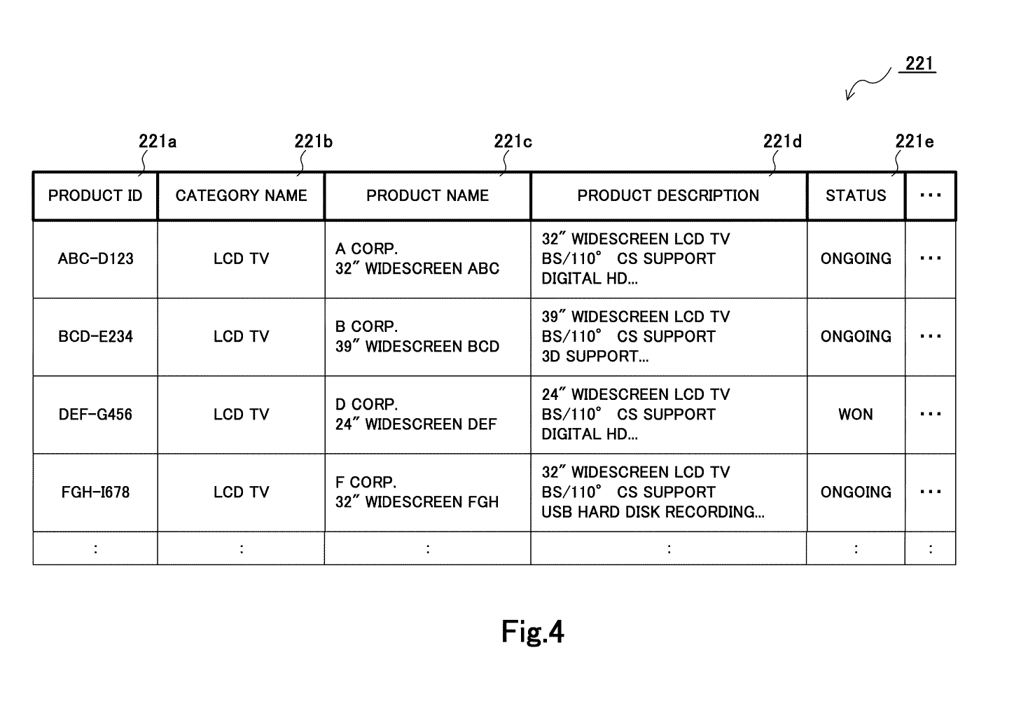

The data storage 220 stores various information related to products put up for auction, and various information related to users. For example, the data storage 220 stores product information 221 as illustrated in FIG. 4. The product information 221 includes, for example, a product ID 221a, a category name 221b, a product name 221c, a product description 221d, and a status 221e. The status 221e indicates the current status of an auction for that product. In addition, the product information 221 may also include information such as image data of a product.

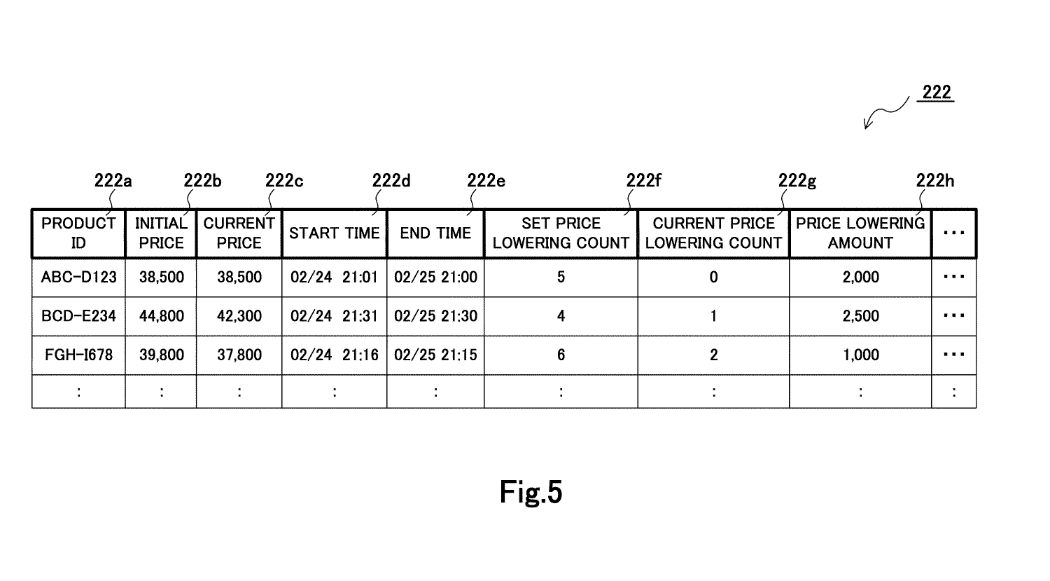

In addition, the data storage 220 stores auction management information 222 as illustrated in FIG. 5. The auction management information 222 is information for managing auctions of products currently up for auction. The auction management information 222 includes, for example, a product ID 222a, an initial price 222b, a current price 222c, a start time 222d, an end time 222e, a set price lowering count 222f, a current price lowering count 222g, and a price lowering amount 222h. Of these, the initial price 222b indicates the original price when the auction for the product first started. The current price 222c indicates the current price of the product, and as discussed later, is decreased (lowered) every time automatic price lowering is conducted. The start time 222d and the end time 222e indicate the auction period for the product, and as discussed later, are updated to a new auction period every time a product is put up for auction again after automatic price lowering. Also, the set price lowering count 222f indicates the total number of times to conduct automatic price lowering configured for the product. The current price lowering count 222g indicates the number of times that automatic price lowering has actually been conducted for the product, and is incremented by 1 every time automatic price lowering is conducted. In other words, automatic price lowering is conducted (if there are no bids) until the value of the current price lowering count 222g becomes equal to the value of the set price lowering count 222f. The price lowering amount 222h indicates the amount by which to lower the price of the product one time, and as discussed later, the current price 222c is decreased by this value every time automatic price lowering is conducted.

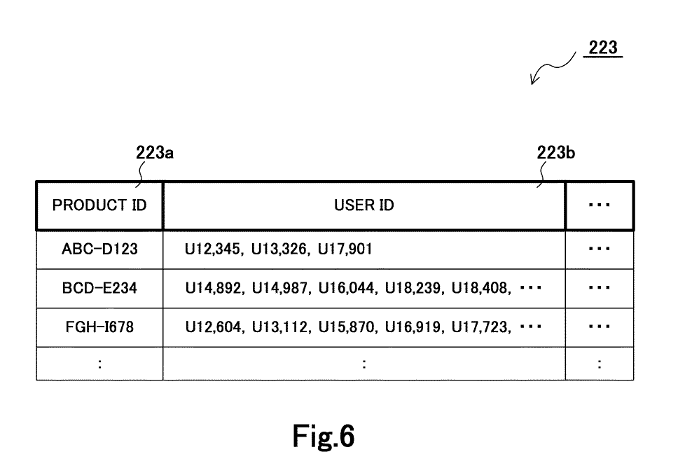

Furthermore, the data storage 220 stores active user management information 223 as illustrated in FIG. 6. The active user management information 223 is information for managing active users indicating an interest in a product up for auction, and as an example, includes a product ID 223a and a user ID 223b. For example, if the user conducts an operation of registering a product in a watch list on an auction screen discussed later, the active user management information 223 is updated by associating identification information of the registering user (the user ID 223b) with that product (product ID 223a). The watch list will be discussed in detail later.

Besides the above, the data storage 220 stores information such as user information input from the receiver 210 (such as a user ID, password, and email address, for example), and financial account information for making payments or credit card information. The RAM 403, auxiliary memory 409, and the like discussed earlier may function as the data storage 220.

Returning to FIG. 3, the controller 230 controls the auction server 200 overall. The controller 230 includes a screen generator 231, an updater 232, a manager 233, a bid processor 234, an announcement processor 235, a counter-bid processor 236, and a decider 237, and respectively controls the auction for each product.

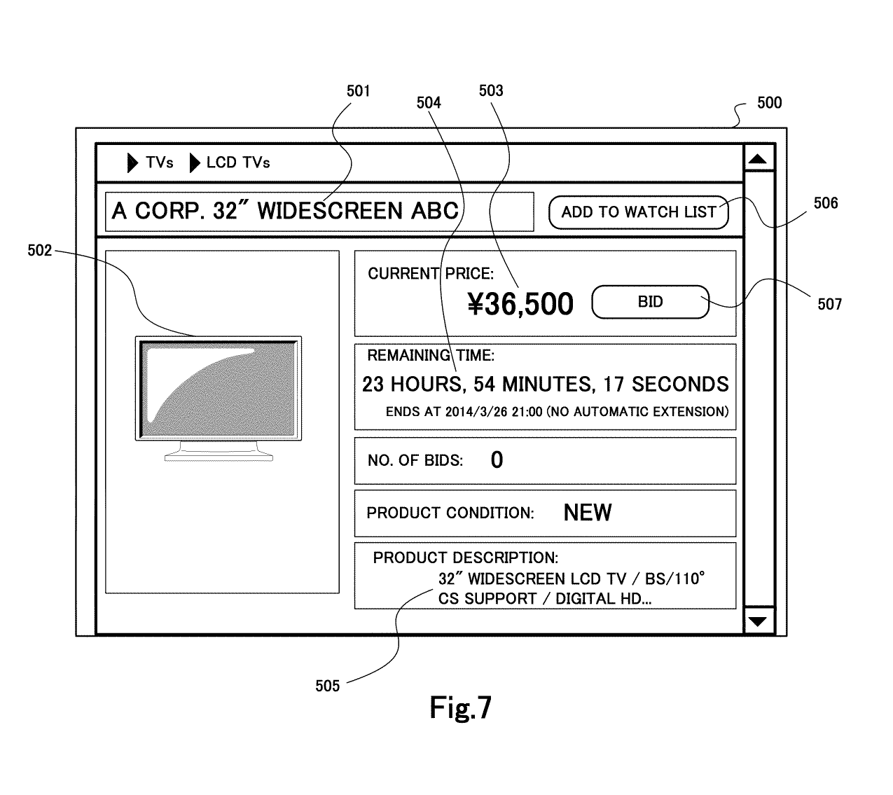

The screen generator 231 generates various screens according to accesses from the user terminal 300. For example, in the case of receiving from the user terminal 300 a request to browse auctions specifying a user-desired product, the screen generator 231 generates an auction screen 500 as illustrated in FIG. 7, for example. As an example, the auction screen 500 includes a product name 501, a product image 502, a current price 503, a remaining time 504, a product description 505, a Register button 506, and a Bid button 507. Of these, the Register button 506 is a button to be clicked with a mouse or the like when the user wants to register the product in a watch list. Note that a watch list is a list for simplifying user browsing, similar to bookmarks in a browser. Also, the Bid button 507 is a button to be clicked with a mouse or the like when the user wants to bid on the product at the current price. The screen generator 231 generates such an auction screen 500 on the basis of the product information 221 and the auction management information 222 discussed above. The generated auction screen 500 is provided to and displayed on the user terminal 300 by the provider 240.

Returning to FIG. 3, the updater 232 intermittently lowers the set price (current price) at which a product put up for auction may be won. For example, the updater 232 continuously monitors the auction management information 222 as illustrated in FIG. 5 discussed above, and in the case of a product whose auction period has ended (that is, the current time has reached the end time 222e), checks the price lowering count (that is, checks whether or not the value of the set price lowering count 222f minus the value of the current price lowering count 222g is equal to or greater than 1), and then automatically lowers the current price (the value of the current price 222c equals the value of the current price 222c minus the value of the price lowering amount 222h). Subsequently, the updater 232 adds 1 to the price lowering count (the value of the current price lowering count 222g), and after updating the auction period (the start time 222d and the end time 222e), puts up the product for auction again.

The manager 233 manages active users indicating an interest in a product. In other words, if the Register button 506 on the auction screen 500 in FIG. 7 discussed above is clicked by a user's mouse operation, the manager 233 updates the active user management information 223 in FIG. 6 discussed above by associating the identification information of the registering user (user ID 223b) with the corresponding product (product ID 223a).

If a bid request is received from the user terminal 300 via the receiver 210, the bid processor 234 accepts a bid at the current set price (current price) for the product. In other words, if the Bid button 507 on the auction screen 500 in FIG. 7 discussed above is clicked by a user's mouse operation, the bid processor 234 accepts a bid at the current price 503.

If the bid time at which the bid processor 234 accepts a bid is within a predetermined announcement period starting from the time of an automatic price lowering by the updater 232, the announcement processor 235 announces, to active users excluding the bidding user, counter-bidding at the set price for the product prior to the relevant price lowering. Note that the announcement period may have a fixed value (for example, 10 minutes), or a variable value that depends on the product. For example, the value may be variable depending on the number of active users. As one example, the announcement processor 235 may reference the active user management information 223 in FIG. 6 discussed above, and if the number of users (the user ID 223b) for the product (the product ID 223a) exceeds a prescribed number (for example, 10 persons), the announcement processor 235 may change the announcement period (for example, by adding 5 minutes to yield a total of 15 minutes). Additionally, if the bid time is within an announcement period starting from the time of an automatic price lowering (in other words, the time of the start time 222d), the announcement processor 235 references the active user management information 223 in FIG. 6 and user information (not illustrated) stored in the data storage 220, and transmits an announcement email from the email transmitter 250 to active users excluding the bidding user.

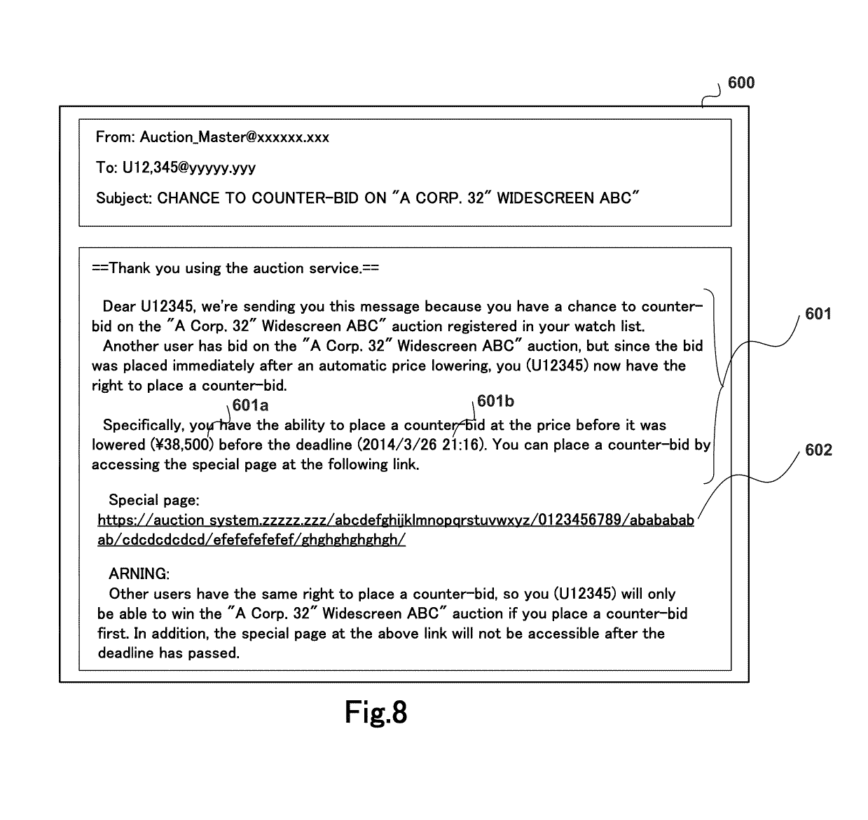

The announcement processor 235 generates an announcement email 600 as illustrated in FIG. 8, for example. As an example, the announcement email 600 includes announcement text 601 and a link 602. The announcement text 601 expresses details announcing counter-bidding to active users of the product that was bid on (users who registered the product in the watch list discussed earlier). More specifically, the announcement text 601 includes a list price 601a prior to price lowering that indicates the counter-bid price, and a deadline time 601b that indicates a time limit for counter-bidding. The deadline time 601b is a time equal to the end of the announcement period, or the time after a fixed period elapses from the bid time, for example. As an example, if the remaining time from the current time to the end of the announcement period (that is, the time obtained by adding the announcement period to the time of the start time 222d) is shorter than a fixed time, the announcement processor 235 sets the time after a fixed period elapses from the bid time as the deadline time 601b. On the other hand, if the remaining time until the end of the announcement period is at least a fixed time, the announcement processor 235 sets the time equal to the end of the announcement period as the deadline time 601b. The link 602 includes the address of a dedicated page for counter-bidding. For this reason, when a user who has received the announcement email 600 clicks on the link 602 with a mouse, the display transitions to a dedicated page for counter-bidding.

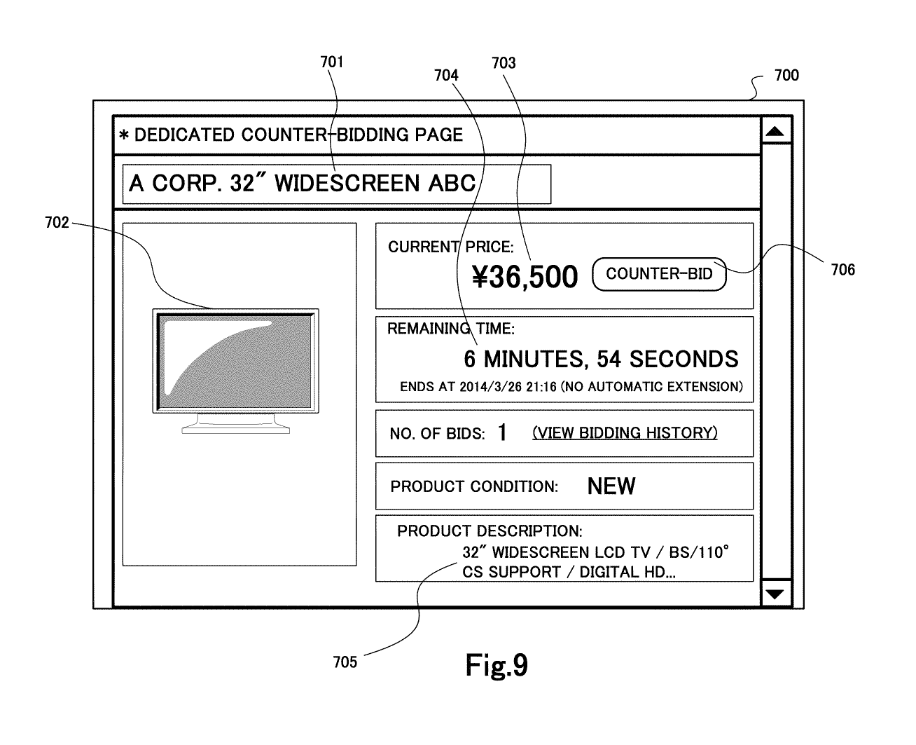

Returning to FIG. 3, if a counter-bid request is received from the user terminal 300 via the receiver 210, the counter-bid processor 236 accepts a counter-bid at the set price for the product prior to price lowering (the previous current price). For example, when a user who has received the announcement email 600 in FIG. 8 discussed above clicks on the link 602 with a mouse, a dedicated counter-bidding screen (dedicated counter-bidding page) 700 as illustrated in FIG. 9 is displayed on that user terminal 300.

The dedicated counter-bidding screen 700 includes a product name 701, a product image 702, a current price 703, a remaining time 704, a product description 705, and a Counter-bid button 706. The dedicated counter-bidding screen 700 is a screen similar to the auction screen 500 in FIG. 7 discussed earlier, but the current price 703 indicates the price of the product before the price was lowered. Also, the remaining time 704 indicates the time until the time limit on counter-bidding (the counter-bidding deadline). Additionally, the Counter-bid button 706 is a button to be clicked with a mouse or the like when the user wants to counter-bid on the product at the set price prior to price lowering. Subsequently, if the Counter-bid button 706 is clicked by a user's mouse operation, the counter-bid processor 236 accepts a counter-bid at the current price 703 (the set price prior to price lowering).

Returning to FIG. 3, the decider 237 decides a winning user on the basis of the bid accepted by the bid processor 234 and the counter-bid accepted by the counter-bid processor 236. For example, if there is a counter-bid before the end of the time limit on counter-bidding (the counter-bidding deadline), the decider 237 decides that the counter-bidding user is the winning user. Note that if there are counter-bids from multiple users, the fastest (earliest) counter-bidding user is decided as the winning user. On the other hand, if there are no counter-bids by the end of the time limit on counter-bidding, the decider 237 decides that the bidding user is the winning user. In addition, the decider 237 also decides that the bidding user is the winning user when the counter-bidding announcement process is not conducted (that is, when the announcement email 600 discussed above is not transmitted).

Besides the above, the controller 230 conducts other processes, such as deleting a relevant record from the auction management information 222 discussed above if the auction period elapses without any bids from users even after automatic price lowering is conducted the configured number of times. The CPU 401 and the like discussed earlier may function as the controller 230 having such a configuration.

The provider 240 provides various information to the user terminal 300 via the Internet 900. For example, the provider 240 provides the user terminal 300 with the auction screen 500 illustrated in FIG. 7 discussed earlier, and the dedicated counter-bidding screen 700 illustrated in FIG. 9 discussed earlier. The CPU 401, NIC 404, and the like discussed earlier may function as such a provider 240.

The email transmitter 250 transmits an email to the user terminal 300 via the Internet 900 (more specifically, to an email address registered in the user information). For example, the email transmitter 250 transmits the announcement email 600 illustrated in FIG. 8 discussed earlier to active users excluding the bidding user. The CPU 401, NIC 404, and the like discussed earlier may function as such an email transmitter 250.

(Operation of Auction Server)

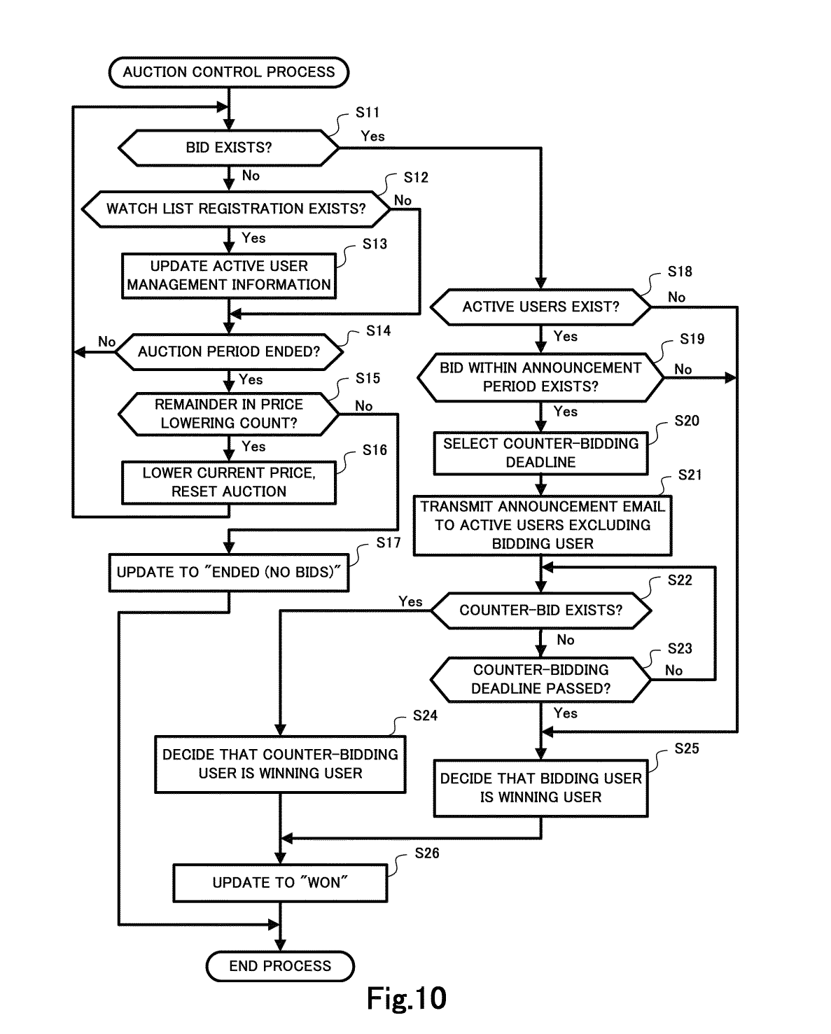

Hereinafter, operation of an auction server 200 with such a configuration will be described with reference to the drawings. FIG. 10 is a flowchart illustrating a flow of an auction control process executed by the auction server 200. Separate instances of the auction control process may be executed in parallel for each product put up for auction, for example. In other words, the following process is a process that controls the auction for one product (the product of interest).

First, the auction server 200 determines whether or not there is a bid on the product of interest from a user (step S11). For example, the controller 230 (bid processor 234) determines that there is a bid from a user if the Bid button 507 is clicked by a user's mouse operation while an auction screen 500 as illustrated in FIG. 7 discussed earlier is being displayed on the user terminal 300.

If it is determined that there are no bids (step S11; No), the auction server 200 determines whether or not a user has registered the product of interest in a watch list (step S12). For example, the controller 230 (manager 233) determines that there is a watch list registration if the Register button 506 is clicked by a user's mouse operation while an auction screen 500 as illustrated in FIG. 7 discussed earlier is being displayed on the user terminal 300. If it is determined that there are no watch list registrations (step S12; No), the auction server 200 proceeds to the processing in step S14 discussed later.

On the other hand, if it is determined that there is a watch list registration (step S12; Yes), the auction server 200 updates the active user management information 223 as illustrated in FIG. 6 discussed earlier (step S13). For example, the controller 230 (manager 233) updates the active user management information 223 by associating the identification information of the registering user (user ID 223b) with the product of interest (product ID 223a of the product of interest) in the active user management information 223 of FIG. 6 discussed earlier.

The auction server 200 determines whether or not the auction period of the product of interest has ended (step S14). For example, the controller 230 (updater 232) determines whether or not the current time has reached the time of the end time 222e of the product of interest in the auction management information 222 as illustrated in FIG. 5 discussed earlier. If it is determined that the auction period has not ended (step S14; No), the auction server 200 returns to the processing in step S11 discussed above.

On the other hand, if it is determined that the auction period has ended (step S14; Yes), the auction server 200 determines whether or not there is a remainder in the price lowering count (step S15). For example, the controller 230 (updater 232) determines that there is a remainder in the price lowering count if the value of the current price lowering count 222g for the product of interest in the auction management information 222 as illustrated in FIG. 5 discussed earlier is smaller than the value of the set price lowering count 222f (in other words, the value of the set price lowering count 222f minus the value of the current price lowering count 222g is at least 1).

If it is determined that there is a remainder in the price lowering count (step S15; Yes), the auction server 200 lowers the current price, and restarts the auction (step S16). For example, the controller 230 (updater 232) subtracts the value of the price lowering amount 222h from the value of the current price 222c for the product of interest in the auction management information 222 as illustrated in FIG. 5 discussed earlier. In addition to the above, the controller 230 adds 1 to the value of the current price lowering count 222g in the auction management information 222, updates the auction period (start time 222d, end time 222e), and then puts up the product for auction again. Subsequently, the auction server 200 returns to the processing in step S11 discussed above.

In the above step S15, if it is determined that there is not a remainder in the price lowering count (step S15; No), the auction server 200 updates the status 221e of the product of interest in the product information 221 of FIG. 4 discussed earlier to “Ended (no bids)”, which indicates that the auction ended without any bids (step S17). Subsequently, the auction server 200 ends the auction control process.

Meanwhile, in the above step S11, if it is determined that there is a bid (step S11; Yes), the auction server 200 determines whether or not there is an active user for the product of interest (step S18). For example, the controller 230 (announcement processor 235) determines whether or not a user ID 223b is associated with the product of interest in the active user management information 223 as illustrated in FIG. 6 discussed earlier. If it is determined that there are no active users (step S18; No), the auction server 200 proceeds to the processing in step S25 discussed later.

Meanwhile, if it is determined that there is an active user (step S18; Yes), the auction server 200 determines whether or not there is a bid within an announcement period starting from the time of an automatic price lowering (step S19). For example, the controller 230 (announcement processor 235) determines whether or not the announcement period has elapsed since the price lowering that was conducted in the above step S16. Note that the announcement period may have a fixed value (for example, 10 minutes), or a variable value that depends on the product. For example, the value may be variable depending on the number of active users. As one example, the controller 230 may change the announcement period (for example, by adding 5 minutes to yield a total of 15 minutes) if the number of active users referenced in the above step S18 exceeds a prescribed number (for example, 10 persons). If it is determined that there are no bids within the announcement period (step S19; No), the auction server 200 proceeds to the processing in step S25 discussed later.

On the other hand, if it is determined that there is a bid within the announcement period (step S19; Yes), the auction server 200 selects a counter-bidding deadline (step S20). For example, if the remaining time from the current time to the end of the announcement period (that is, the time obtained by adding the announcement period to the time of the start time 222d) is shorter than a fixed time, the controller 230 (announcement processor 235) selects the time after a fixed period elapses from the bid time as the counter-bidding deadline. On the other hand, if the remaining time until the end of the announcement period is at least a fixed time, the announcement processor 235 selects the time equal to the end of the announcement period as the counter-bidding deadline.

The auction server 200 transmits an announcement email to active users, excluding the bidding user (step S21). For example, the controller 230 (announcement processor 235) generates an announcement email 600 as illustrated in FIG. 8 discussed earlier to active users excluding the bidding user.

The auction server 200 determines whether or not there is a counter-bid from a user (step S22). For example, the controller 230 (counter-bid processor 236) determines that there is a counter-bid from a user if the Counter-bid button 706 is clicked by a user's mouse operation while a dedicated counter-bidding screen 700 as illustrated in FIG. 9 discussed earlier is being displayed on the user terminal 300.

If it is determined that there are no counter-bids (step S22; No), the auction server 200 determines whether or not the counter-bidding deadline has passed (step S23). For example, the controller 230 (counter-bid processor 236) determines whether or not the current time has reached the counter-bidding deadline selected in the above step S20. If it is determined that the counter-bidding deadline has not passed (step S23; No), the auction server 200 returns to the processing in step S22 discussed above.

In the above step S22, if it is determined that there is a counter-bid (step S22; Yes), the auction server 200 decides that the counter-bidding user is the winning user (step S24). In other words, the controller 230 (decider 237) decides that the user who placed a counter-bid before the counter-bidding deadline is the winning user. Note that if there are counter-bids from multiple users, the fastest (earliest) counter-bidding user is decided as the winning user. Note that the winning price in this case is the current price for the counter-bid (that is, the set price before price lowering).

On the other hand, if it is determined in the above step S23 that the counter-bidding deadline has passed (step S23; Yes), if it is determined in the above step S18 that there are no active users (step S18; No), or if it is determined in the above step S19 that there are not bids within the announcement period (step S19; No), the auction server 200 decides that the bidding user is the winning user (step S25). Note that the winning price in this case is the current price for the bid (that is, the set price after price lowering).

The auction server 200 updates the status 221e of the product of interest in the product information 221 of FIG. 4 discussed earlier to “Won”, which indicates that the auction ended with a winning bid (step S26). Subsequently, the auction server 200 ends the auction control process.

According to such an auction control process, bids from users are obtained sooner. In other words, with an automatic price lowering auction of the related art, many users bid at the cheap price immediately after the automatic price lowering, but with the auction control process of the present disclosure, since there is a risk of being overturned by a counter-bid, there is a greater incentive to bid before automatic price lowering, and bids from users are obtained sooner. Also, a product may be auctioned at a higher price with a bid before automatic price lowering. Note that even if there is a bid at the cheap price immediately after automatic price lowering as in the related art, if there is a counter-bid, the auction is won at the price before automatic price lowering, and thus a product may be auctioned at a higher price. As a result, it is possible to obtain bids from users sooner in an automatic price lowering auction.

### Other Embodiments

The foregoing embodiment describes the case of providing a field for a price lowering amount 222h in the auction management information 222 illustrated in FIG. 5 discussed earlier, and conducting automatic price lowering by subtracting the value of the price lowering amount 222h from the current price 222c. However, the price lowering method is arbitrary, and not limited to the above. For example, instead of the price lowering amount 222h, a field for a price lowering ratio may be provided in the auction management information 222, and when conducting automatic price lowering, an amount corresponding to the price lowering ratio may be subtracted from the current price 222c.

The foregoing embodiment describes that, when there is a bid from a user, the announcement processor 235 determines whether or not the bid time is within a predetermined announcement period starting from the time of an automatic price lowering, and also describes that the announcement period may be variable depending on the number of active users. However, the method of varying the announcement period is arbitrary, and not limited to such variation on the basis of the number of active users. For example, the announcement processor 235 may also vary the announcement period depending on the price lowering amount or the above price lowering ratio used by the updater 232.

The foregoing embodiment describes a case in which, if the decider 237 decides that the counter-bidding user is the winning user, the bidding user does not receive any compensation. However, in such cases, compensation may be given to the bidding user who lost the auction. For example, the controller 230 may additionally include a granter that grants points to be used when paying for a product won by auction. Subsequently, on the condition that the decider 237 decides that the counter-bidding user is the winning user, some or all of the points that would normally be granted to the user who pays for the product (the paying user) may be granted to the bidding user instead. In this case, by obtaining points, the bidding user who lost the auction may be recompensed for the effort spent on the auction.

The foregoing embodiment describes a case in which the announcement processor 235 (email transmitter 250) announces counter-bidding to active users excluding the bidding user by transmitting an email message (announcement email), but the method of announcing counter-bidding is arbitrary, and not limited to such an email message. For example, the announcement processor 235 may also announce counter-bidding by using a microblogging server such as Twitter (registered trademark).

### INDUSTRIAL APPLICABILITY

As described above, according to the present disclosure, it is possible to provide an auction server, an auction control method, a non-transitory recording medium, and a program enabling bids from users to be obtained sooner on an automatic price lowering auction.

### REFERENCE SIGNS LIST

100 auction system

200 auction server

210 receiver

220 data storage

230 controller

231 screen generator

232 updater

233 manager

234 bid processor

235 announcement processor

236 counter-bid processor

237 decider

240 provider

250 email transmitter

300 user terminal

400 information processing device

401 CPU

402 ROM

403 RAM

404 NIC

405 image processor

406 audio processor

407 DVD-ROM drive

408 interface

409 auxiliary memory

410 controller

411 monitor

412 speaker

900 Internet

1. An auction server comprising:
an updater that intermittently lowers a set price at which a product put up for auction is winnable;
a provider that provides the current set price of the product to a plurality of users;
a manager that manages one or more active users indicating an interest in the product from among the plurality of users provided with the set price;
a bid receiver that receives a bid at the current set price for the product from a bidding user among the plurality of users;
an announcer that, if a bid time at which the bid is received by the bid receiver is within a predetermined announcement period starting from a time of a price lowering of the product by the updater, announces, to the active users excluding the bidding user, counter-bidding at the set price for the product prior to the relevant price lowering;
a counter-bid receiver that receives a counter-bid from a counter-bidding user among the active users to which counter-bidding was announced, until a counter-bidding deadline determined from the price lowering time or the bid time; and
a decider that decides a winning user on the basis of the bid received by the bid receiver and the counter-bid received by the counter-bid receiver.

2. The auction server according to claim 1, wherein
the announcer varies the announcement period according to the number of active users.

3. The auction server according to claim 1, wherein
the announcer varies the announcement period according to a price lowering amount or a price lowering ratio used by the updater.

4. The auction server according to claim 1, wherein
the counter-bidding deadline is equal to the end of the announcement period, or after a fixed period elapses from the bid time.

5. The auction server according to claim 1, further comprising:
a granter that, on the condition that the decider decides that the counter-bidding user is the winning user, grants some or all of points to be granted to the winning user for use when paying for a product won by auction to the bidding user.

6. An auction control method in a server that controls an auction, comprising:
an updating step that intermittently lowers a set price at which a product put up for auction is winnable;
a providing step that provides the current set price of the product to a plurality of users;
a managing step that manages one or more active users indicating an interest in the product from among the plurality of users provided with the set price;
a bid receiving step that receives a bid at the current set price for the product from a bidding user among the plurality of users;
an announcing step that, if a bid time at which the bid is received in the bid receiving step is within a predetermined announcement period starting from a time of a price lowering of the product in the updating step, announces, to the active users excluding the bidding user, counter-bidding at the set price for the product prior to the relevant price lowering;
a counter-bid receiving step that receives a counter-bid from a counter-bidding user among the active users to which counter-bidding was announced, until a counter-bidding deadline determined from the price lowering time or the bid time; and
a deciding step that decides a winning user on the basis of the bid received in the bid receiving step and the counter-bid received in the counter-bid receiving step.

7. A non-transitory computer-readable recording medium storing a program causing a computer to function as:
an updater that intermittently lowers a set price at which a product put up for auction is winnable;
a provider that provides the current set price of the product to a plurality of users;
a manager that manages one or more active users indicating an interest in the product from among the plurality of users provided with the set price;
a bid receiver that receives a bid at the current set price for the product from a bidding user among the plurality of users;
an announcer that, if a bid time at which the bid is received by the bid receiver is within a predetermined announcement period starting from a time of a price lowering of the product by the updater, announces, to the active users excluding the bidding user, counter-bidding at the set price for the product prior to the relevant price lowering;
a counter-bid receiver that receives a counter-bid from a counter-bidding user among the active users to which counter-bidding was announced, until a counter-bidding deadline determined from the price lowering time or the bid time; and
a decider that decides a winning user on the basis of the bid received by the bid receiver and the counter-bid received by the counter-bid receiver.

8. (canceled)
